(19) United States
(12) Patent Application Publication
(10) Pub. No.: US 2026/0049232 A1
(43) Pub. Date: Feb. 19, 2026

(54) WAX COMPOSITION AND ASSOCIATED SPRAY PRODUCT, PRODUCTION METHOD, AND METHOD OF USE

(71) Applicant: Harrison Aquino, Buffalo, NY (US)

(72) Inventor: Harrison Aquino, Buffalo, NY (US)

(21) Appl. No.: 19/298,405

(22) Filed: Aug. 13, 2025

Related U.S. Application Data
(60) Provisional application No. 63/682,423, filed on Aug. 13, 2024.

(51) Int. Cl. C09G 3/00; A63B 59/70; A63B 102/24

(52) U.S. Cl. CPC C09G 3/00; A63B 59/70; A63B 2102/24

(57) ABSTRACT

A wax composition contains a primary oil/wax (e.g., 30 to 95 vol %), a natural wax (e.g., 5 to 30 vol %), optionally a solvent (e.g., 0 to 20 vol %), and optionally a fragrance (e.g., (0 to 5 vol %). The wax composition may be suitable for application to sporting equipment, such as hockey stick blades. The composition may include paraffin oil, soy wax, isopropyl alcohol, and pine needle essential oil.

This application claims the benefit of U.S. Provisional Application No. 63/682,423 filed Aug. 13, 2024, the contents of which are incorporated by reference herein.

### BACKGROUND

The present disclosure relates to a sprayable, non-pressurized wax composition. The composition may be particularly useful for application to a hockey stick blade. However, it is also contemplated that the composition may be used for application to other sporting goods and non-sporting goods. The wax composition may improve at least one of traction and grip of the article to which the composition is applied. Spray products containing the wax composition, methods for producing the wax composition, methods for producing the spray product, and methods for applying the wax composition to an article are also disclosed.

A wax layer applied to a hockey stick blade or tape applied to a hockey stick blade may enhance the ability of a player to control the puck by acting as a protective layer against snow, ice, or moisture and/or increasing friction. The wax layer may also increase the useful life of the hockey stick blade or tape applied thereto.

Known hockey wax products are typically in the form of a solid bar that is applied by rubbing the product on the blade or applied tape.

It would be desirable to develop new, sprayable wax compositions.

### BRIEF DESCRIPTION

Disclosed, in some embodiments, is a wax composition containing: 30 vol % to 95 vol % of a primary wax or oil; 5 vol % to 30 vol % of a natural wax; 0 vol % to 20 vol % of a solvent; and 0 vol % to 5 vol % of a fragrance.

In some embodiments, the wax composition includes: 60 vol % to 85 vol % of the primary wax or oil; 10 vol % to 25 vol % of the natural wax; 3 vol % to 15 vol % of the solvent; and 0.5 vol % to 4 vol % of the fragrance.

The wax composition may include: 65 vol % to 80 vol % of the primary wax or oil; 12 vol % to 22 vol % of the natural wax; 5 vol % to 12 vol % of the solvent; and 1 vol % to 3 vol % of the fragrance.

In some embodiments, the wax composition contains: 70 vol % to 75 vol % of the primary wax or oil; 14 vol % to 20 vol % of the natural wax; 6 vol % to 10 vol % of the solvent; and 1.5 vol % to 2.5 vol % of the fragrance.

The wax composition may include about 73 vol % of the primary wax or oil; about 17 vol % of the natural wax; about 8 vol % of the solvent; and about 2 vol % of the fragrance.

Disclosed, in other embodiments, is a wax composition containing: 40 wt % to 86 wt % of a primary wax or oil; 10 wt % to 50 wt % of a natural wax; 0 wt % to 10 wt % of a solvent; and 0 wt % to 5 wt % of a fragrance.

The wax composition may include: 50 wt % to 76 wt % of the primary wax or oil; 15 wt % to 45 wt % of the natural wax; 1 wt % to 7 wt % of the solvent; and 0.5 wt % to 4 wt % of the fragrance.

In some embodiments, the wax composition contains: 55 wt % to 71 wt % of the primary wax or oil; 22 wt % to 40 wt % of the natural wax; 2 wt % to 6 wt % of the solvent; and 1 wt % to 3 wt % of the fragrance.

The wax composition may include: 60 wt % to 66 wt % of the primary wax or oil; 27 wt % to 35 wt % of the natural wax; 3 wt % to 5 wt % of the solvent; and 1.5 wt % to 2.5 wt % of the fragrance.

In some embodiments, the wax composition contains: about 63 wt % of the primary wax or oil; about 31 wt % of the natural wax; about 4 wt % of the solvent; and about 2 wt % of the fragrance.

In some embodiments, the primary wax or oil comprises paraffin oil.

The natural wax may be soy wax.

In some embodiments, the solvent comprises isopropyl alcohol.

The fragrance may be pine needle essential oil.

Methods for treating an article are also disclosed and may include applying the wax composition to the article.

The wax composition may be applied via spraying.

In some embodiments, the article is a piece of sporting equipment.

The article may be a hockey stick blade.

Spray products are also disclosed and may include: a container having a spray nozzle; and the wax composition within the container.

In some embodiments, the spray nozzle is a mister-type spray nozzle.

Processes for preparing the wax composition are also disclosed and may include liquefying the natural wax; mixing the liquefied natural wax with a solvent to form a first mixture; mixing the first mixture with the primary wax or oil to form a second mixture; and mixing the second mixture with a fragrance to form the wax composition.

In some embodiments, the natural wax is liquefied using a double boiler system operated at a temperature above a melting point of the natural wax but below the boiling point of water.

A different mixer or agitator may be used in each mixing step.

In some embodiments, the mixer or agitator comprises a glass stirring rod.

Processes for preparing a spray product assembly are also disclosed and may include providing the wax composition to a container; and applying a spray nozzle to the container.

The product assembly may be shaken or otherwise mixed/agitated for homogeneity.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a non-limiting example of a method for producing a wax composition in accordance with some embodiments of the present disclosure.

FIG. 2 is a flow chart illustrating a non-limiting example of a method for producing a spray product in accordance with some embodiments of the present disclosure.

FIG. 3 is a photograph of a non-limiting example of a spray product assembly in accordance with some embodiments of the present disclosure.

FIG. 4 is a photograph of a portion of the spray product assembly of FIG. 3.

FIG. 5 is a photo photograph of a portion of the spray product assembly of FIG. 3.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable.

The term “vol %” refers to the percentage by volume of a component of a composition wherein the volumes are measured at room temperature with the exception of the natural wax, the volume or which is measured when the temperature is elevated such that the natural wax is in a non-viscous liquid form. The wax compositions of the present disclosure may form relatively homogenous mixtures and the volumes refer to the amount of each component included in the mixture prior to the combination thereof.

The term wt % refers to the percentage by weight of a component of a composition relative to the total weight of the composition.

The terms “agitation” and related variants refer to mixing to homogenize a composition. Agitation may be mechanical (e.g., shaking, stirring) or non-mechanical (e.g., ultrasonic mixing).

The present disclosure relates to a composition for improving the performance of sports equipment, including recreational sports equipment, and may be particularly useful on hockey stick blades. Further, the present disclosure relates to a method of manufacturing said composition.

The composition is a sprayable, non-pressurized (non-aerosol) wax composition that improves at least one of traction or a grip of an article upon which the composition is sprayed. The article may be a piece of sporting equipment, such as the blade of a hockey stick, not is not limited thereto.

The wax composition contains a primary oil or wax, a natural wax, and a solvent. Optionally, the wax composition further contains at least one fragrance and/or tackifier. In some embodiments, the same ingredient functions as a fragrance and a tackifier. The fragrance may include an essential oil.

The primary oil/wax component may include an oil and/or a wax. Non-limiting examples of suitable primary oils/waxes include paraffin wax, paraffin oil, mineral oil, and polyolefin wax. The polyolefin wax may be selected from polyethylene wax and polypropylene wax.

The natural wax may be a plant wax. For example, the natural wax may be a vegetable wax.

Non-limiting examples of natural waxes include soy wax, carnauba wax, candelilla wax, cotton seed wax, bayberry wax, myrtle wax, palm kernel wax, Japan wax, animal wax, beeswax, Chinese wax, lanolin, sugar cane wax, sunflower wax, olive wax, rice bran wax, pea wax, coconut wax, palm tree wax, and tallow-based wax. Combinations of two or more of these natural waxes are also contemplated.

The natural wax may have a melting point in a range of from about 105° F. to about 130° F., including from about 110° F. to about 125° F., and about 115° F. to about 121° F.

The solvent may be an alcohol solvent, an ester solvent, an ether solvent, a hydrocarbon solvent, a chloro solvent, a polar aprotic solvent, a nitrile solvent, or a ketone solvent.

Non-limiting examples of alcohol solvents include methanol, ethanol, isopropyl alcohol, n-propanol, and butanol.

Non-limiting examples of ester solvents include ethyl acetate, methyl acetate, n-butyl acetate, isobutyl acetate, sec-butyl acetate, and isopropyl acetate.

Non-limiting examples of ether solvents include tetrahydrofuran, diethylether, methyltert-butylether, and dioxane.

Non-limiting examples of hydrocarbon solvents include toluene, xylene, cyclohexane, hexane, heptane, and n-pentane.

Non-limiting examples of polar aprotic solvents include dimethylformamide, dimethylacetamide, and dimethylsulfoxide.

Non-limiting examples of nitrile solvents include acetonitrile.

Non-limiting examples of ketone solvents include acetone and methyl isobutyl.

Non-limiting examples of fragrances include citronella essential oil, eucalyptus essential oil, clove oil, thyme essential oil, lemongrass essential oil, peppermint essential oil, cinnamon essential oil, lavender essential oil, tea tree essential oil, rosemary essential oil, sweet orange essential oil, chamomile essential oil, rose essential oil, hyssop essential oil, clay sage essential oil, ylang ylang essential oil, myrrh essential oil, vetiver essential oil, frankincense essential oil, helychrysum essential oil, chrysanthemum essential oil, grapefruit essential oil, cedarwood essential oil, pine tree essential oil, spearmint essential oil, basil essential oil, melaleuca essential oil, arborvitae essential oil, cassia essential oil, oregano essential oil, agar essential oil, ajwain essential oil, angelica root essential oil, anise essential oil, asafetida essential oil, balsam of Peru essential oil, bay essential oil, bergamot essential oil, black pepper essential oil, bachu essential oil, birch essential oil, camphor essential oil, calamodin essential oil, caraway seed essential oil, calamus essential oil, coconut essential oil, coffee essential oil, coriander oil, costmary essential oil, costus root essential oil, cranberry seed essential oil, cubeb essential oil, cumin seed essential oil, black seed essential oil, cypress essential oil, cypriol essential oil, curry leaf essential oil, davana essential oil, dill essential oil, elecampane essential oil, elemi essential oil, fennel seed essential oil, fenugreek essential oil, fir essential oil, galangal essential oil, galbanum essential oil, garlic essential oil, geranium essential oil, ginger essential oil, goldenrod essential oil, grapefruit essential oil, henna essential oil, helichrysum essential oil, hickory nut essential oil, horseradish essential oil, tansy essential oil, jasmine essential oil, juniper berry essential oil, lemon essential oil, ledum essential oil, lime essential oil, mandarin essential oil, mango essential oils, marjoram essential oil, lemon balm essential oil, moringa essential oil, mugwort essential oil, mustard essential oil, myrtle essential oil, neem essential oil, neroli essential oil, nutmeg essential oil, orris essential oil, palo santo essential oil, parsley essential oil, patchouli essential oil, perilla essential oil, petitgrain essential oil, pineapple essential oil, ravensara essential oil, red cedar essential oil, rosehip essential oil, rosewood essential oil, sandalwood essential oil, sassafras essential oil, savory essential oil, schisandra essential oil, spearmint oil, spruce essential oil, star anise essential oil, tangerine essential oil, tarragon essential oil, tsuga essential oil, turmeric essential oil, valerian essential oil, warionia essential oil, western red cedar essential oil, wintergreen essential oil, and yarrow essential oil. Combinations of two or more of these fragrances are also contemplated.

Unscented wax compositions are also contemplated.

The wax composition generally does not contain any propellant. In some embodiments, the wax composition does not contain propane, butane, or isobutane.

The following Table describes various examples and ranges (in wt %) for each component. It should be understood that the examples are non-limiting and that endpoint from different ranges may be combined

| Material | | First | Second | Third | Fourth | Fifth |
|---|---|---|---|---|---|---|
| Type | Example | Range | Range | Range | Range | Range |
| Primary | Paraffin | 40-86 | 50-76 | 55-71 | 60-66 | About 63 |
| wax/oil | oil | | | | | |
| Natural | Soy wax | 10-50 | 15-45 | 22-40 | 27-35 | About 31 |
| Wax | | | | | | |
| Solvent/ | Isopropyl | 0-10 | 1-7 | 2-6 | 3-5 | About 4 |
| Liquefier | alcohol | | | | | |
| Fragrance | Essential | 0-5 | 0.5-4 | 1-3 | 1.5-2.5 | About 2 |
| | oil of pine | | | | | |
| | needle | | | | | |

The following Table describes various examples and ranges (in vol %) for each component. It should be understood that the examples are non-limiting and that endpoint from different ranges may be combined.

| Material | | First | Second | Third | Fourth | Fifth |
|---|---|---|---|---|---|---|
| Type | Example | Range | Range | Range | Range | Range |
| Primary | Paraffin | 30-95 | 60-85 | 65-80 | 70-75 | About 73 |
| wax/oil | oil | | | | | |
| Natural | Soy wax | 5-30 | 10-25 | 12-22 | 14-20 | About 17 |
| Wax | | | | | | |
| Solvent/ | Isopropyl | 0-20 | 3-15 | 5-12 | 6-10 | About 8 |
| Liquefier | alcohol | | | | | |
| Fragrance | Essential | 0-5 | 0.5-4 | 1-3 | 1.5-2.5 | About 2 |
| | oil of pine | | | | | |
| | needle | | | | | |

In particular embodiments, the composition includes about 73 vol % of a primary wax/oil component (e.g., liquid paraffin oil); about 17 vol % of a natural wax (e.g., pure soy wax); about 8% of a solvent/liquefier (e.g., 99% anhydrous isopropyl alcohol); and about 2 vol % of a fragrance/additional tackifier (e.g., essential oil of pine needle).

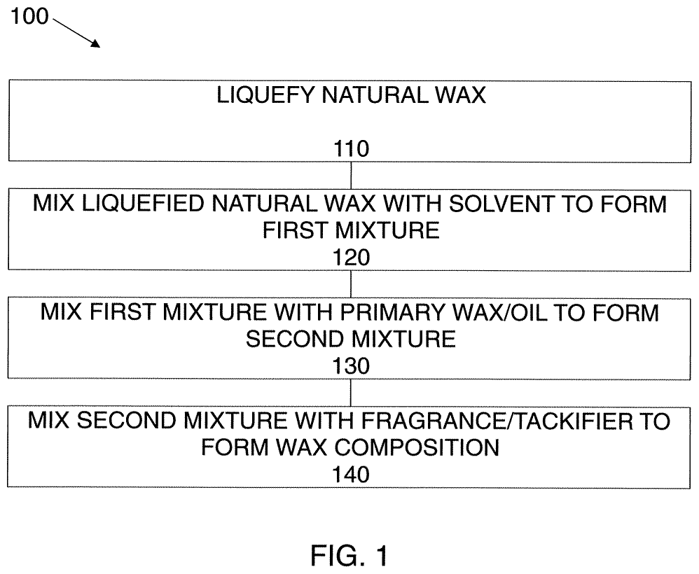

FIG. 1 illustrates a non-limiting embodiment of a process 100 for forming a wax composition in accordance with some embodiments of the present disclosure. The method 100 includes liquefying a natural wax 110, mixing the liquefied natural wax with a fluid/solvent to form a first mixture 120, mixing the first mixture with a primary wax or oil to form a second mixture 130, and mixing the second mixture with a fragrance and/or tackifier to form the wax composition 140.

Aside from the natural wax, each of the other ingredients may be introduced at or near room temperate (about 70° F.). In some embodiments, the order of addition of ingredients may be adjusted. For example, while the natural wax and fluid (e.g., alcohol) are typically mixed together prior to being combined with the other ingredients, it is contemplated that the mixing of the first mixture with the primary wax or oil and the fragrance may be combined. In some embodiments, the primary wax or oil and the fragrance are mixed together prior to being combined with the first mixture (i.e., the mixture of the natural wax and the fluid).

In some embodiments, the liquefying 110 is performed using a double boiler system. The double boiler system may include a first container for housing the natural wax and a second container for a heated liquid (e.g., water). The first container may be placed above or partially submerged in the second container.

The temperature in the second container is elevated above a melting temperature of the natural wax but below the boiling point of the liquid contained therein (e.g., 212° F. for water). In some embodiments, the water temperature is maintained at a temperature in a range of from 70° F. to 130° F., including from 80° F. to 120° F., from 90° F. to 110° F., or about 100° F. The natural wax must be heated until it forms a non-viscous liquid.

The liquefied natural wax is mixed 120 with a solvent to form a first mixture. The ingredients may be mixed in clean, residue-free glassware. An agitator such as a glass stirrer may be utilized in the mixing step 120.

The first mixture is mixed 130 with a primary wax or oil to form a second mixture. The primary wax or oil may be kept isolated in a separate container to avoid contamination from any outside source (e.g., dust, dirt, etc.). The primary wax or oil may be added to the container used in the prior mixing step 120. An agitator such as a glass stirrer may be utilized in the mixing step 130. The agitator may be different from an agitator used in the mixing step 120.

The second mixture is mixed 140 with a fragrance/tackifier to form the wax composition. The agitator may be different from the agitator(s) used in the mixing steps 120, 130.

It is contemplated that each mixing step 120, 130, 140 may be performed in the same mixer/container. Alternatively, the mixing steps may be performed in separate mixers/containers. It is also possible to perform mixing steps 120, 130 in a first mixer/container and mixing step 140 in a second mixer/container; or to perform mixing step 120 in a first mixer/container and mixing steps 130, 140 in a second mixer/container.

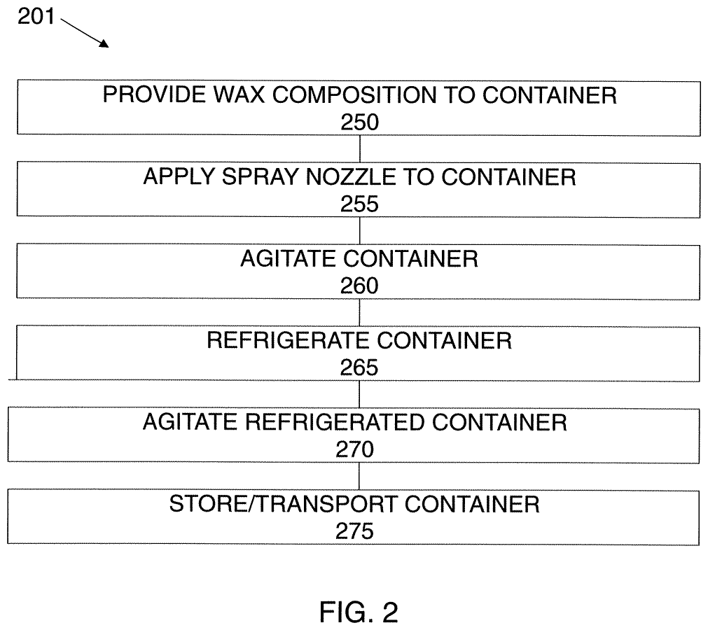

In some embodiments, the precursor compositions are mixed properly at each step until the composition is clear and void of opaque qualities. FIG. 2 illustrates a non-limiting embodiment of a process 201 for producing a spray product in accordance with some embodiments of the present disclosure. The method 201 includes providing a wax composition to a container 250, applying a spray nozzle to the container 255, agitating the container 260, refrigerating the container 265, agitating the refrigerated container 270, and storing and/or transporting the container 275.

Each agitation step 260, 270 is also optional. However, the ingredients should be properly mixed during the formation of the composition. If the ingredients are not properly mixed, the composition may be inhomogeneous and separate into distinct phases, thereby preventing the composition from being properly sprayed and/or from having the desired properties once applied to the intended article. In some embodiments, the contents are shaked or otherwise agitated after the composition is provided to the container and/or after the spray nozzle is applied thereto.

The wax composition provided 250 to the container may be the composition formed in the process 100 of FIG. 1. The container may be selected to protect the contents from UV radiation. For example, the container may be a glass amber bottle.

A spray nozzle is applied 255 to the container. The spray nozzle may be a mister-type nozzle. The interface between the nozzle and container should form a seal.

The assembly is agitated 260. Agitation may be performed via vigorous shaking. The shaking may be conducted by hand or automatic. In some embodiments, the agitation 260 is performed for a time period of from 10 second to 3 minutes, including from 20 seconds to 2 minutes, and from 30 seconds to 1 minute.

The assembly is optionally refrigerated 265. The refrigeration 265 may last at least 4 minutes, including at least 6 minutes, at least 8 minutes, and at least 10 minutes. The temperature should not go below 33° F. In some embodiments, the temperature does not go below 45° F., below 40° F., or below 35° F. In particular embodiments, the target temperature is room temperature (i.e., about 70° F.) and this may be achieved without or without the assistance of refrigeration.

The assembly is agitated 270. Agitation may be performed via vigorous shaking. The shaking may be conducted by hand or automatic. In some embodiments, the agitation 280 is performed for a time period of from 10 second to 3 minutes, including from 20 seconds to 2 minutes, and from 30 seconds to 1 minute.

The means for agitation in steps 260 and 270 may be the same or different. In some embodiments, both are performed manually. In other embodiments, both are performed automatically. In further embodiments, the first agitation step 260 is performed manually, and the second agitation step 270 is performed automatically or the first agitation step 260 is performed automatically and the second agitation step 270 is performed manually.

The product is shelf-stable and ready for storage and/or transportation 275. In the event that the contents separate in the mixture, they can be re-homogenized via agitation by an end user.

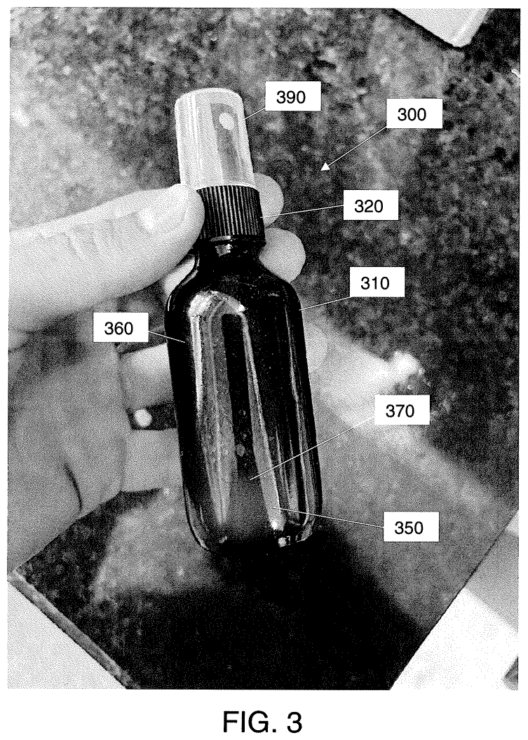

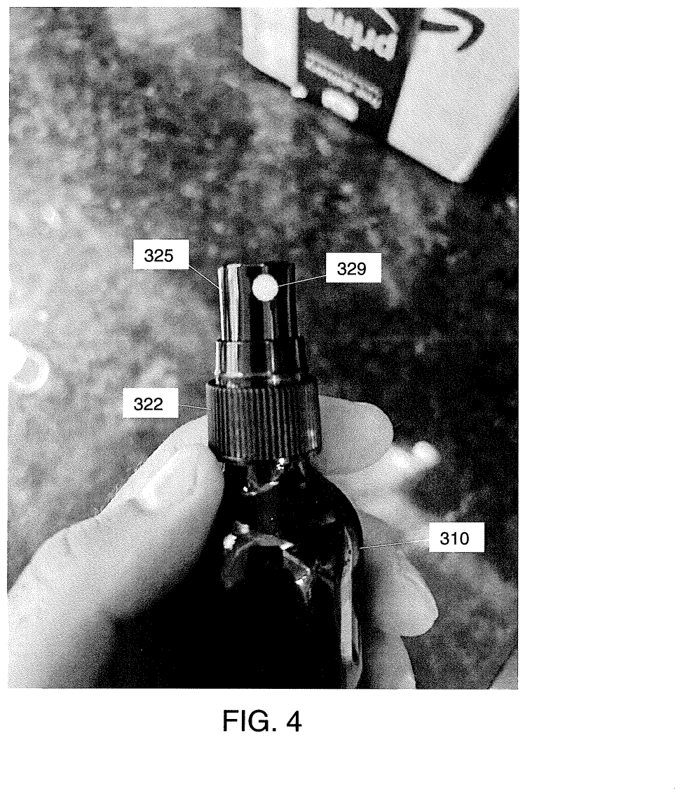

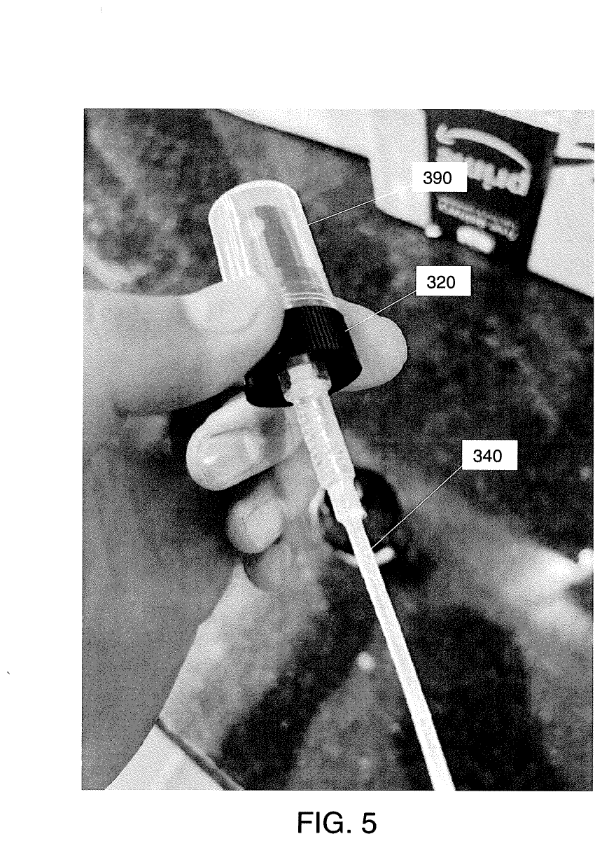

FIGS. 3-5 are photographs illustrating aspects of a non-limiting example of a spray product assembly 300 in accordance with some embodiments of the present disclosure. The assembly 300 includes a container body 310 (e.g., glass such as amber glass), the wax composition within the container body 350, a top 320 (e.g., plastic), and a protective cover 390 (e.g., plastic). The top 320 includes a connecting portion 322 for securing the top 320 to the container body 310 and a pump actuator 325 having a nozzle 329 for spraying the wax composition onto a desired surface. The connecting portion 322 includes a connecting element that is complementary to a connecting element of the container body 310. For example, a neck of the container body 310 may be threaded and the connecting portion 322 of the top 320 may include complementary threads. It is also contemplated that the top 320 may snap onto the container body 310. A seal or gasket may be provided at an interface between the top 320 and container body 310. A tube 340 is fluidly connected to the nozzle 329. When the pump actuator 325 is pressed, pressure in a headspace 360 in the container above the wax composition 350 is increased. This exerts a force on the wax composition 350 and, if the tube 340 extends below a liquid line 370 into the wax composition 350, then some of the wax composition 350 is drawn into the tube 340, provided to the nozzle 329, and sprayed out. The protective cap 390 aids in protecting the contents of the assembly from the outside environment and prevents accidental discharge caused by inadvertent activation of the actuator 325.

The following examples are provided to illustrate the compositions, spray products, and methods of the present disclosure. The examples are merely illustrative and are not intended to limit the disclosure to the materials, conditions, or process parameters set forth therein.

### EXAMPLES

All preparation was performed in clean, residue-free, laboratory grade glass beakers.

A double boiler system was used to heat pure soy wax. In particular, water was provided to a first container and pure soy wax was provided to a second container of the system. The water was heated to a temperature below the boiling point of water (212° F.) until the pure soy wax was formed into a non-viscous liquid. The liquefied pure soy wax was provided to a first beaker.

10 mL of the liquefied pure soy wax was mixed with 5 mL of 99% anhydrous isopropyl alcohol. In particular, the alcohol was provided from a second beaker to the first beaker and then mixed. A first glass stirring rod was used to mix the ingredients prior to transfer to the next step.

44 mL of liquid paraffin oil was measured out and kept isolated to avoid contamination with any outside source (e.g., dust, dirt, etc.). The paraffin oil was mixed with the previously mixed soy wax and isopropyl alcohol. In particular, the mixture contained in the first beaker was provided to a third beaker containing the paraffin oil. A second glass stirring rod was used to mix the ingredients.

1 mL of essential oil of pine needle was measured and provided to a clean glass beaker. The essential oil of pine needle was mixed with the previously mixed soy wax, isopropyl alcohol, and paraffin oil. In particular, the contents of the third beaker and a fourth beaker containing the essential oil of pine needle were provided to a product bottle. A third glass stirring rod was used to mix the ingredients.

Cross-mixing with the beaker that holds the essential oil for measurement should be avoided. The essential oil can be poured directly from the measuring beaker either into the bottle where it will receive the mixture of paraffin oil, wax, and isopropyl alcohol, or it can be mixed in when those ingredients are being mixed before the final step of pouring it in the product bottle.

The product bottle was a 60 mL (2 oz) glass amber bottle. A mister-type spray nozzle was attached. The contents were shaken vigorously for 30 seconds to 1 minute and subsequently refrigerated for at least 10 minutes while the temperature did not go below 33° F. After removal from refrigeration, the contents were shaken again for 30 seconds to 1 minute. The resulting product exhibited shelf stability and was ready for storage and/or transportation.

Other waxes, including pure paraffin wax, microcrystalline wax, and beeswax, were also tested but led to compositions having inferior properties compared to soy wax.

Various alcohols were also tested but only isopropyl alcohol (e.g., 99% isopropyl alcohol) achieved the desired properties.

This written description uses examples to describe the disclosure, including the best mode, and also to enable any person skilled in the art to make and use the disclosure. Other examples that occur to those skilled in the art are intended to be within the scope of the present disclosure if they have structural elements that do not differ from the same concept, or if they include equivalent structural elements with insubstantial differences. It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A wax composition comprising:
30 vol % to 95 vol % of a primary wax or oil;
5 vol % to 30 vol % of a natural wax;
0 vol % to 20 vol % of a solvent; and
0 vol % to 5 vol % of a fragrance.

2. The wax composition of claim 1, wherein the primary wax or oil comprises paraffin oil; wherein the natural wax comprises soy wax; wherein the solvent comprises isopropyl alcohol; and wherein the fragrance comprises pine needle essential oil.

3. The wax composition of claim 2, wherein the wax composition comprises:
60 vol % to 85 vol % of the primary wax or oil;
10 vol % to 25 vol % of the natural wax;
3 vol % to 15 vol % of the solvent; and
0.5 vol % to 4 vol % of the fragrance.

4. The wax composition of claim 2, wherein the wax composition comprises:
65 vol % to 80 vol % of the primary wax or oil;
12 vol % to 22 vol % of the natural wax;
5 vol % to 12 vol % of the solvent; and
1 vol % to 3 vol % of the fragrance.

5. The wax composition of claim 2, wherein the wax composition comprises:
70 vol % to 75 vol % of the primary wax or oil;
14 vol % to 20 vol % of the natural wax;
6 vol % to 10 vol % of the solvent; and
1.5 vol % to 2.5 vol % of the fragrance.

6. The wax composition of claim 2, wherein the wax composition comprises:
about 73 vol % of the primary wax or oil;
about 17 vol % of the natural wax;
about 8 vol % of the solvent; and
about 2 vol % of the fragrance.

7. A method for treating an article, the method comprising:
applying the wax composition of claim 2 to the article.

8. The article of claim 7, wherein the article is a hockey stick blade.

9. A spray product comprising:
a container having a spray nozzle; and
the wax composition of claim 2 within the container;
wherein the container is not pressurized.

10. A process for preparing the wax composition of claim 2, the process comprising:
liquefying the natural wax;
mixing the liquefied natural wax with a solvent to form a first mixture;
mixing the first mixture with the primary wax or oil to form a second mixture; and
mixing the second mixture with a fragrance to form the wax composition.

11. The process of claim 10, wherein the natural wax is liquefied using a double boiler system operated at a temperature above a melting point of the natural wax but below the boiling point of water.

12. The process of claim 10, wherein a different mixer or agitator is used in each mixing step.

13. A process for preparing a spray product assembly comprising:
providing the wax composition of claim 2 to a container; and
applying a spray nozzle to the container.

14. The process of claim 13, further comprising:
refrigerating the spray product assembly.

15. A wax composition comprising:
40 wt % to 86 wt % of a primary wax or oil;
10 wt % to 50 wt % of a natural wax;
1 wt % to 7 wt % of the solvent; and
0.5 wt % to 4 wt % of the fragrance.

16. The wax composition of claim 1, wherein the primary wax or oil comprises paraffin oil; wherein the natural wax comprises soy wax; and wherein the solvent comprises isopropyl alcohol.

17. The wax composition of claim 16, wherein the fragrance comprises pine needle essential oil.

18. The wax composition of claim 16, wherein the wax composition comprises:
55 wt % to 71 wt % of the primary wax or oil;
22 wt % to 40 wt % of the natural wax;
2 wt % to 6 wt % of the solvent; and
1 wt % to 3 wt % of the fragrance.

19. The wax composition of claim 16, wherein the wax composition comprises:
60 wt % to 66 wt % of the primary wax or oil;
27 wt % to 35 wt % of the natural wax;
3 wt % to 5 wt % of the solvent; and
1.5 wt % to 2.5 wt % of the fragrance.

20. The wax composition of claim 16, wherein the wax composition comprises:
about 63 wt % of the primary wax or oil;
about 31 wt % of the natural wax;
about 4 wt % of the solvent; and
about 2 wt % of the fragrance.
